(19) United States
(12) Patent Application Publication
(10) Pub. No.: US 2024/0401394 A1
(43) Pub. Date: Dec. 5, 2024

(54) WINDOW SYSTEM FOR MOTOR VEHICLE CONFIGURED TO MOVE WINDOW TO PRE-DROP POSITION

(71) Applicant: Ford Global Technologies, LLC, Dearborn, MI (US)

(72) Inventors: Howard Paul Tsvi Linden, Delray Beach, FL (US); Rafic Jergess, Warren, MI (US); Asaa Harajli, Canton, MI (US); Wolfgang Frank Loewe, Livonia, MI (US); Onoyom Essien Ekanem, White Lake, MI (US)

(21) Appl. No.: 18/203,852

(22) Filed: May 31, 2023

(51) Int. Cl. E05F 15/76; B60J 1/17; B60J 10/77; E05F 15/71

(52) U.S. Cl. CPC E05F 15/76; B60J 1/17; B60J 10/77; E05F 15/71; B60L 50/60; E05F 17/00; E05Y 2400/44; E05Y 2900/55

(57) ABSTRACT

This disclosure relates to a window system for a motor vehicle. The window system is configured to move one or more windows to a pre-drop position. A corresponding method is also disclosed. In some aspects, the techniques described herein relate to a window system for a motor vehicle, including: a window moveable between a fully closed position, a pre-drop position, and a short drop position; a sensor system configured to generate signals indicative of a presence of a recognized user adjacent the motor vehicle, and indicative of a proximity of the recognized user to the motor vehicle; and a controller configured to instruct the window to move from the fully closed position to the pre-drop position when a signal from the sensor system indicates the recognized user is adjacent the motor vehicle.

### TECHNICAL FIELD

This disclosure relates to a window system for a motor vehicle. The window system is configured to move one or more windows to a pre-drop position. A corresponding method is also disclosed.

### BACKGROUND

Some motor vehicles, such as convertibles, sport utility vehicles (SUVs), etc., include doors with frameless windows. When a door with a frameless window is closed, and when the window is in the fully closed position, an upper edge of the window is configured to seal relative to a seal assembly mounted to a body of the motor vehicle.

### SUMMARY

In some aspects, the techniques described herein relate to a window system for a motor vehicle, including: a window moveable between a fully closed position, a pre-drop position, and a short drop position; a sensor system configured to generate signals indicative of a presence of a recognized user adjacent the motor vehicle, and indicative of a proximity of the recognized user to the motor vehicle; and a controller configured to instruct the window to move from the fully closed position to the pre-drop position when a signal from the sensor system indicates the recognized user is adjacent the motor vehicle.

In some aspects, the techniques described herein relate to a window system, wherein the controller is configured instruct the window to move from the fully closed position to the pre-drop position when the signal from the sensor system indicates the recognized user is within about 3 meters of the motor vehicle.

In some aspects, the techniques described herein relate to a window system, wherein: the controller is configured to instruct the window system to wake up from a low power mode when a signal from the sensor system indicates a recognized user is within a first threshold distance of the motor vehicle, the controller is configured to instruct the window to move from the fully closed position to the pre-drop position when a signal from the sensor system indicates the recognized user is within a second threshold distance of the motor vehicle, and the second threshold distance is less than the first threshold distance.

In some aspects, the techniques described herein relate to a window system, wherein the first threshold distance is about 10 meters, and the second threshold distance is about 3 meters.

In some aspects, the techniques described herein relate to a window system, wherein: the window is a first window, the window system further includes a second window moveable between a fully closed position, a pre-drop position, and a short drop position, and when the signal from the sensor system indicates the recognized user is adjacent the motor vehicle, the controller is configured to instruct a closer one of the first window and the second window to the recognized user to move from the fully closed position to the pre-drop position.

In some aspects, the techniques described herein relate to a window system, further including: a door, wherein the window is moveable such that a height of an upper edge of the window relative to an upper edge of the door is variable in response to instructions from the controller; and a seal mounted to a body section of the motor vehicle, wherein the body section is adjacent an upper edge of a window opening selectively covered and uncovered by movement of the window, wherein, when the window is in the fully closed position, an upper edge of the window is within the seal, wherein, when the window is in the pre-drop position, the upper edge of the window is within the seal but the upper edge of the window is arranged at a lesser height than in the fully closed position, and wherein, when the window is in the short drop position, the upper edge of the window is not within the seal.

In some aspects, the techniques described herein relate to a window system, wherein the upper edge of the window moves a lesser distance when moving between the pre-drop and the short drop positions than when moving between the fully closed and short drop positions.

In some aspects, the techniques described herein relate to a window system, wherein the upper edge of the window moves a distance within a range of about 10-18 mm when moving between the pre-drop and the short drop positions, and the upper edge of the window moves a distance of about 2 mm between the fully closed and pre-drop positions.

In some aspects, the techniques described herein relate to a window system, wherein, when the window is in the pre-drop and short drop positions, there is a vertical clearance between the upper edge of the window and the body section such that the door can be moved from the fully closed position without the upper edge of the window contacting the body section.

In some aspects, the techniques described herein relate to a window system, further including: a door mounted relative to an opening in a body of the motor vehicle such that the door is moveable between a fully closed position and a fully open position; a door release assembly configured to permit movement of the door from the fully closed position, and wherein, when the door release assembly is activated, the controller is configured to instruct the window to move from the pre-drop position to the short drop position.

In some aspects, the techniques described herein relate to a window system, wherein the door release assembly includes one or both of a door handle and a door presenter.

In some aspects, the techniques described herein relate to a window system, wherein the controller is configured to instruct the window to move from the pre-drop position to the fully closed position if the door release assembly is not activated within a predefined time period.

In some aspects, the techniques described herein relate to a window system, wherein the controller is configured to instruct the window to move from the fully closed position to the pre-drop position when a transmission of the motor vehicle is shifted into park from a gear other than park.

In some aspects, the techniques described herein relate to a window system, wherein the controller is configured to instruct the window to move from the fully closed position to the pre-drop position when an ignition of the motor vehicle is in an off position.

In some aspects, the techniques described herein relate to a window system, wherein the controller is configured to instruct the window to move from the fully closed position to the pre-drop position when an ambient temperature is below a threshold temperature.

In some aspects, the techniques described herein relate to a window system, wherein the controller is configured to instruct the window to move from the fully closed position to the pre-drop position when the motor vehicle is not operating in a normal operating condition.

In some aspects, the techniques described herein relate to an electrified vehicle, including: a battery pack configured to deliver power to propel the electrified vehicle; a window moveable between a fully closed position, a pre-drop position, and a short drop position; and a controller configured to instruct the window to move from the fully closed position to the pre-drop position when a state of charge of the battery pack is less than a threshold.

In some aspects, the techniques described herein relate to an electrified vehicle, wherein the threshold is a 40% state of charge.

In some aspects, the techniques described herein relate to a method, including: moving a window of a motor vehicle from a fully closed position to a pre-drop position when a recognized user is adjacent the motor vehicle.

In some aspects, the techniques described herein relate to a method, further including: waking up a window system of the motor vehicle when the recognized user is within a first threshold distance of the motor vehicle; and moving the window from the fully closed position to the pre-drop position when the recognized user is within a second threshold distance of the motor vehicle, wherein the second threshold distance is less than the first threshold distance.

### BRIEF DESCRIPTION OF THE DRAWINGS

FIG. 1 is a front perspective view an example motor vehicle.

FIG. 2 is a front perspective view of the motor vehicle of FIG. 1 with a door in a fully open position. The door includes a frameless window.

FIG. 3 is a cross-sectional view illustrating an interface of a seal and the window, taken along line 3-3. In FIG. 3, the window is in a fully closed position.

FIG. 4 is a cross-sectional view of the interface of the seal and the window similar to FIG. 3, with the window in a short drop position.

FIG. 5 is a cross-sectional view of the interface of the seal and the window similar to FIGS. 3 and 4, with the window in a pre-drop position.

FIG. 6 is a schematic, top view of the motor vehicle, and in particular illustrates an example sensor system. FIG. 6 also schematically illustrates various movements of a recognized user relative to the motor vehicle.

### DETAILED DESCRIPTION

This disclosure relates to a window system for a motor vehicle. The window system is configured to move one or more windows to a pre-drop position. A corresponding method is also disclosed. Aspects of this disclosure relate to conditions in which moving the window to the pre-drop position will ultimately allow a door of the motor vehicle to be opened sooner than in known designs. Certain aspects of this disclosure also relate to preserving energy and/or anticipating situations where it would be useful to provide the window in the pre-drop position. This disclosure provides for other benefits, which will be appreciated from the following description.

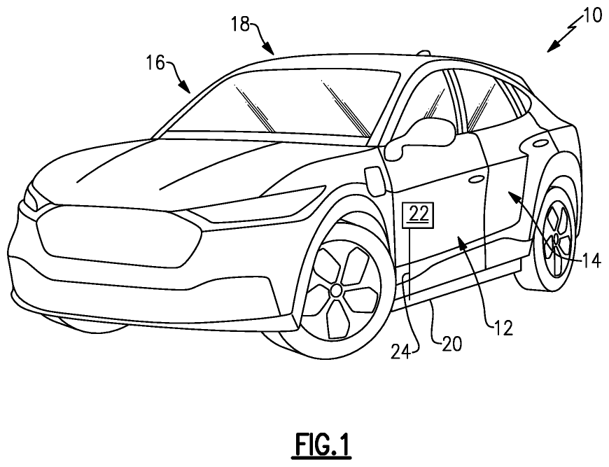

FIG. 1 is a front perspective view of a motor vehicle 10 (“vehicle 10”). In particular, FIG. 1 illustrates a side of the vehicle 10 side referred to as a driver side in regions such as the United States of America. The terms “driver side” and “passenger side” are used in this disclosure for convenience only. This disclosure extends to vehicles where the driver and passenger side are on opposite sides relative to what is shown in the figures. The vehicle 10 is a crossover sport utility vehicle (sometimes referred to as a crossover or a crossover utility vehicle (CUV)) in this example. It should be understood that this disclosure extends to other types of vehicles, such as sedans, sport utility vehicle (SUVs), cars, trucks, vans, etc.

The vehicle 10 includes four doors 12, 14, 16 18 configured to open and close to uncover and cover, respectively, corresponding openings in the body of the vehicle 10 to permit users (i.e., a driver or passengers) to enter and exit the passenger cabin of the vehicle. Door 12 is a front driver side door, while door 14 is a rear driver side door. Door 16 is a front passenger side door, while door 18 is a rear passenger side door. While a four-door vehicle is shown, this disclosure extends to vehicles with another quantity of doors.

The vehicle 10 is an electrified vehicle in one example. In that example, the vehicle 10 includes a high voltage battery pack 20 configured to power one or more electric machines and other electrical loads of the electrified vehicle. The battery pack 20 includes a plurality of battery cells and various other battery internal components that support electric propulsion of the vehicle 10. Ultimately, the battery pack 20 is configured to deliver power to an electric machine that is configured to propel the vehicle 10.

The battery pack 20 state of charge (“SOC”) is the level of charge of battery pack 20 relative to its capacity, and is expressed as percentage herein. When the SOC is low, a user may choose to charge the battery pack 20 at public or private electrified vehicle charging stations, for example, by plugging a plug of the electrified vehicle charging station into the charging port of the vehicle 10. While an electrified vehicle is mentioned herein, aspects of this disclosure are not limited to use with electrified vehicles, and those aspects apply to vehicles that are solely driven by an internal combustion engine, for example.

The vehicle 10 further includes a controller 22. The controller 22 includes electronics, software, or both, to perform the necessary control functions for operating the vehicle 10 and executing various functions of the vehicle 10 and the corresponding window system, which will be discussed below. In one non-limiting embodiment, the controller 22 is a combination vehicle system controller and powertrain control module (VSC/PCM). Although it is shown as a single hardware device, the controller 22 may include multiple controllers in the form of multiple hardware devices, or multiple software controllers within one or more hardware devices. A controller area network (CAN) 24 allows the controller 22 to communicate with the various components of the vehicle 10, including the battery pack 20, and the window system. Various connections of the CAN 24 are represented using lines in the drawings. Further, reference to the controller 22 performing an action in this disclosure includes the controller 22 issuing a command to one or more components which causes that action to occur. Further still, reference to the controller 22 instructing movement of a window, such as the window 32, to a particular position includes the controller 22 instructing the components capable of moving that window, such as the actuator assembly 36, to move the window to that position. In other words, language to the effect of the controller 22 being configured to instruct the window 32 to move to a particular position, is shorthand for the controller 22 being configured to issue one or more instructions, or commands, to the various components of the window system, including actuator assembly 36, to cause the window 32 to move to that particular position.

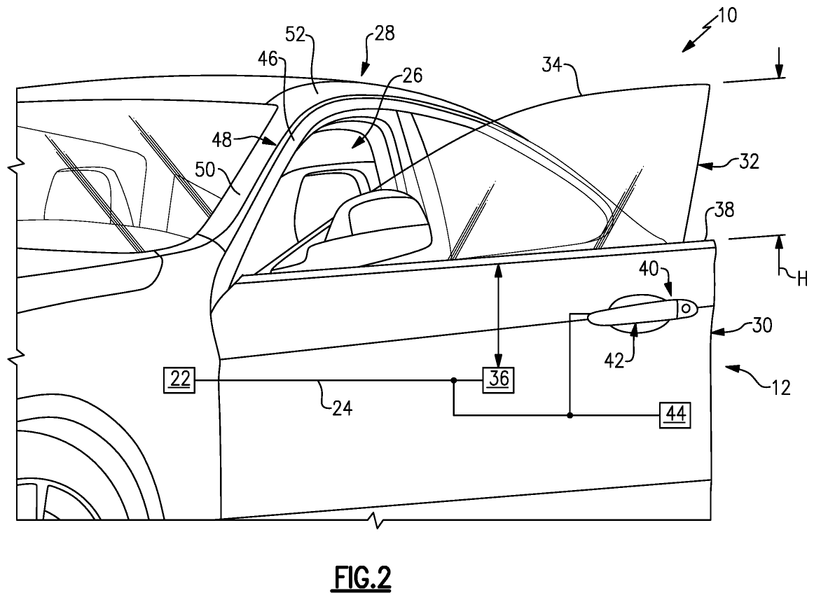

FIG. 2 illustrates the door 12 in a fully open position. While the door 12 is described in detail with reference to FIG. 2, it should be understood that the doors 14, 16, 18 are configured substantially similarly.

As shown, the door 12 is in a fully open position and exposes an opening 26 in a body 28 of the vehicle 10 such that a user, which here may be the driver, can enter and exit the passenger cabin of the vehicle 10. The opening 26 is selectively covered and uncovered by the door 12 as the door moves between the fully closed position (FIG. 1) and the fully open position (FIG. 2). The door 12 includes a main section 30, which is configured to cover a lower portion of the opening 26, and a window 32 which is configured to cover an upper portion of the opening 26.

The window 32, and the components associated with the window 32 or with movement of the window 32, may be referred to as part of a window system. Further, as each of the doors 14, 16, 18 has windows configured substantially similar to window 32, the components associated with each of the windows of each door 12, 14, 16, 18 may be referred to as a window system.

In this disclosure, an upper edge 34 of the window 32 is unbounded by a frame of the door 12. Specifically, the door 12 lacks a rigid structure projecting upward from the main section 30 that is configured to surround the window 32 or support a seal that contacts the window 32 when the window 32 is in the fully closed position. In this regard, the window 32 may be considered a frameless window.

The window 32 is moveable vertically relative to the main section 30 by an actuator assembly 36, which is at least partially contained within the main section 30. In particular, the actuator assembly 36 is configured to raise and lower the window 32 such that a height H of the upper edge 34 of the window 32 relative to an upper edge 38 of the main section 30 is variable. The actuator assembly 36 is responsive to instructions from the controller 22.

The height H is at a maximum when the window 32 is in a fully closed position, and the height H is at a minimum when the window 32 is in a fully open position. In one example, the window 32 is entirely within the main section 30 in the fully open position, such that no portion of the upper edge 34 of the window 32 projects above the upper edge 38 of the main section 30.

The door 12 further includes a door release assembly 40. In this disclosure the door release assembly 40 is a moveable door handle 42. While a moveable door handle 42 is shown, the door handle 42 could be a fixed handle. In that instance, the door release assembly 40 could include a door presenter 44 configured to partially open the door 12 in response to a request from the user, for example. The door 12, or the door handle 42, could include one or more buttons which, when pressed, would cause the controller 22 to instruct the door presenter 44 to move the door 12 to the partially open position. The door 12 further includes latch assembly configured to selectively hold the door 12 relative to the body 28 of the vehicle 10. The controller 22 is in communication with the door release assembly 40. The door release assembly 40 is shown on the exterior of the door 12, but it should be understood that the door release assembly 40 includes components accessible from the passenger cabin of the vehicle 10.

The window 32 is configured to seal relative to a seal 46 mounted to a section 48 of the body 28 adjacent the top of the opening 26. The section 48 is made of a metallic material, such as steel in this example, while the seal 46 is made of a softer material than the section 48, including an elastomeric material such as rubber. The section 48 includes the A-pillar 50 and a portion of an upper side rail 52 of the body 28. The interface of the window 32 and the seal 46 is shown in more detail in FIG. 3.

FIG. 3 illustrates the arrangement of the window 32 relative to the seal 46, with the door 12 in the fully closed position, and the window 32 in the fully closed position. As shown, the upper edge 34 of the window is within the seal 46 and is arranged at a first height H1 relative to the upper edge 38. The first height H1 is a maximum height of the window 32, in this example. Further, in the fully closed position, the upper edge 34 is vertically above bottom edge 54 of an outermost portion of the section 48, which here is specifically a portion of the upper side rail 52. The seal 46 projects vertically below the upper edge 34 and the bottom edge 54. In the position of FIG. 3, the relative positions of the upper edge 34 and the bottom edge 54 prevents movement of the door 12 from the closed position, as the window 32 would abut the section 48 adjacent the bottom edge 54, thereby preventing further movement of the door 12. For reference, movement of the door 12 from the closed position (i.e., toward the open position) would be in the left-hand direction in FIG. 3.

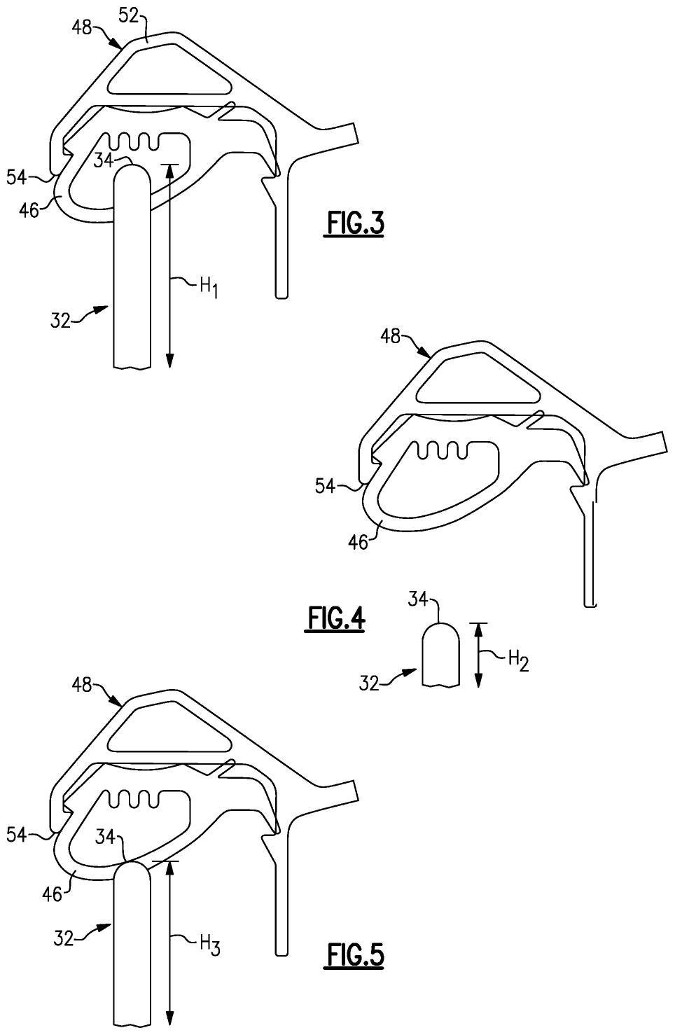

FIG. 4 is a view similar to FIG. 3, but illustrates the window 32 in a short drop position, in which the upper edge 34 of the window is not within the seal 46. In particular, the upper edge 34 is vertically below the seal 46 (i.e., there is a vertical clearance between the upper edge 34 and the seal 46). Further, the upper edge 34 is vertically below the bottom edge 54. In the short drop position, the upper edge 34 is arranged at a second height H2 relative to the upper edge 38. The second height H2 is within a range of about 12 to 20 millimeters less than the first height H1, in this example. When the window 32 is in the short drop position, the door 12 can be moved from the fully closed position, either manually by a user or by the door presenter 44, as examples, without the window 32 contacting the seal 46 or the section 48.

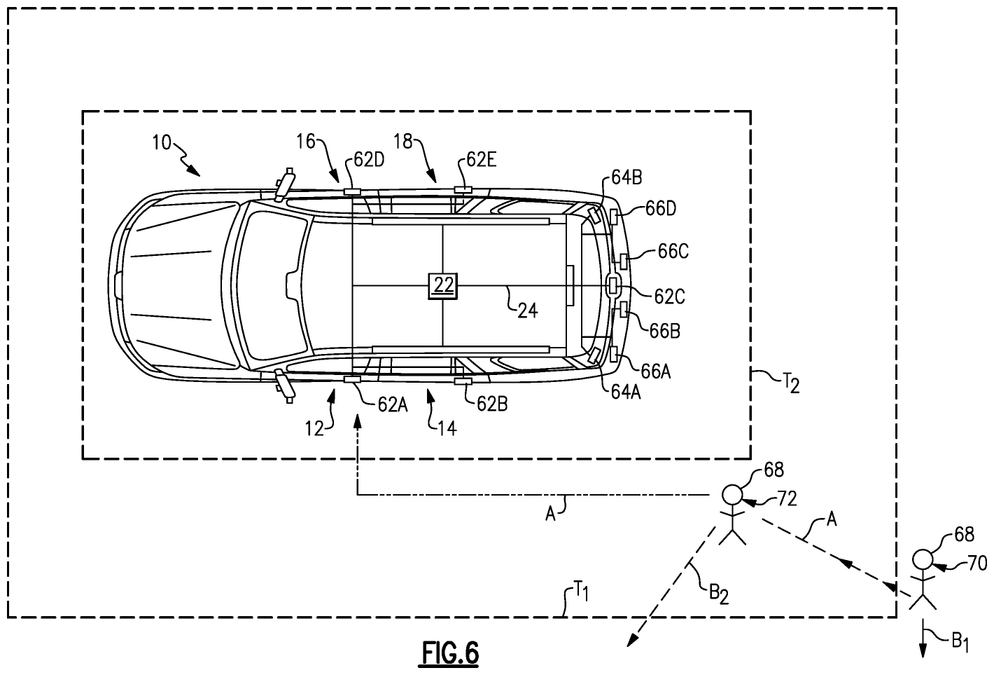

This disclosure relates to reducing the delay in moving the window 32 from the fully closed position of FIG. 3 to the short drop position of FIG. 4. Thus, in this disclosure, the controller 22 monitors for certain conditions and, when present, instructs the window 32 to move to a pre-drop position, as shown in FIG. 5. The pre-drop position is a position in which the upper edge 34 of the window 32 is within the seal 46, but is not positioned as deeply within the seal 46 when compared to the fully closed position.

Specifically, with reference to FIG. 5, the upper edge 34 is arranged at a third height H3 about 2 millimeters less than the first height H1. When the window 32 is arranged in this pre-drop position, it takes less time to move the window 32 to the short drop position of FIG. 4 compared to moving the window 32 from the fully closed position directly to the short drop position. Further, in the pre-drop position, the upper edge 34 is vertically below the bottom edge 54. Thus, while it may be more difficult to open the door 12 when compared to the window 32 being in the short drop position, it is possible for a user to open the door 12 when the window 32 is in the pre-drop position, because there will not be contact between the window 32 and the section 48. Rather, to open the door 12 with the window 32 in the pre-drop position, a user only needs to apply a force sufficient to overcome the force of the seal 46 acting on the window 32.

In an aspect of this disclosure, the controller 22 is in communication with one or more sensors configured to generate signals indicative of a presence of one or more recognized user adjacent the vehicle 10 and indicative of a proximity of the one or more recognized users to the vehicle 10. An example sensor system is shown in FIG. 6.

As represented in FIG. 6, the vehicle 10 includes a plurality of radio detection and ranging (radar) sensors 62A-62E, a plurality of blind spot information system (BLIS) sensors 64A, 64B, and a plurality of ultrasonic sensors 66A-66D. The radar sensors 62A-62E are each located on a respective door 12, 14, 16, 18 of the vehicle 10, in this example. The BLIS sensors 64A, 64B are located adjacent rear corners of the vehicle 10. Further, the ultrasonic sensors 66A-66D are located adjacent a rear bumper of the vehicle 10. Each of the sensors 62A-62E, 64A, 64B, 66A-66D is configured to generate signals corresponding to detected motion, for example, within a respective sensing area. The sensing areas covered by the sensors 62A-62E, 64A, 64B, 66A-66D may overlap. The controller 22 is configured to interpret signals from the sensors 62A-62E, 64A, 64B, 66A-66D to identify objects or people, determine whether those people are recognized users, and to determine the position of the objects or people relative to the vehicle 10.

While a particular sensor arrangement is shown in FIG. 6, this disclosure extends to other sensor arrangements, including other locations, quantities, and types of sensors. For instance, this disclosure extends to vehicles having one or more cameras configured to capture still or video images adjacent the vehicle 10. Such a camera could be part of an existing system of the vehicle 10, such as rear backup camera, a self-driving system (SDS) of the vehicle 10, a front camera, a 360° camera, etc. The camera could also be provided by a sensor of the SDS, such as a laser imaging, detection, and ranging (LIDAR) sensor.

While the sensors 62A-62E, 64A, 64B, 66A-66D have other uses, in this disclosure they are also useable when the vehicle 10 is parked, and in particular are configured to generate signals indicative of activity adjacent the vehicle 10. The term indicative is used herein to refer to both “smart” sensors which can generate detailed signals and relay those signals to the controller 22 and also to signals which require some level of processing by the controller 22 in order for the controller 22 to discern relevant information from the signal.

Still another aspect of this disclosure relates to the identification of people within the area adjacent the vehicle 10 and various responses to recognized and unrecognized people entering the area. In this disclosure, the controller 22 is configured to identify people using one or more known techniques. One technique includes facial recognition. For instance, the controller 22 may have access to one or more faces associated with authorized people, such as the owner of the vehicle 10 and their family. Another technique includes identifying a keyfob or phone as a key (PaaK) corresponding to a particular vehicle 10. In a particular aspect of this disclosure, the controller 22 does not identify the presence of a recognized user in response to a button being pressed on a keyfob of the vehicle 10. Rather, the sensors 62A-62E, 64A, 64B, 66A-66D are able to detect the presence of the keyfob without requiring a user to press any buttons on the keyfob.

One particular aspect of this disclosure relates to moving one or more of the windows of the doors 12, 14, 16, 18 to the pre-drop position when a recognized user is adjacent the vehicle 10. The term adjacent is used to mean nearby, and is specifically intended to refer to being within a range of the sensors 62A-62E, 64A, 64B, 66A-66D. In a particular example, a manufacturer may set a predefined distance, such as 3 meters, and the controller 22 will instruct the window 32 to move the pre-drop position if a recognized user is within 3 meters of the vehicle 10.

In a further aspect of this disclosure, when the vehicle 10 has been parked for a period of time, the controller 22 instructs the window system to enter a sleep mode, in which one or more of the electronic components of the window system enters a low power mode. In the sleep mode, the controller 22 continues to monitor for recognized users in the area adjacent the vehicle 10. In one example, the controller 22 will wake up the window system from the sleep mode when a recognized user is within a first threshold distance T₁ from the vehicle 10. The first threshold distance T₁ is represented by a dashed line spaced-apart from the vehicle 10 by the first threshold distance T₁. The first threshold distance T₁ is about 10 meters, in an example.

In FIG. 6, a recognized user 68 is at location 70 outside the first threshold distance T₁. If the recognized user 68 follows path B₁ and remains outside the first threshold distance T₁, or if the person is not a recognized user, the window system will remain in the sleep mode. If the recognized user 68 follows path A and moves to location 72 within the first threshold distance T₁, the controller 22 will instruct the window system to wake up from the sleep mode. In particular, the controller 22 will instruct the electronic components of the window system to return to a full power mode. In this way, the window system is ready to initiate a movement of the window 32, and/or the windows associated with the other doors 14, 16, 18, to the pre-drop position.

In this example, if the recognized user 68 follows path B₂ and passes back outside the first threshold distance T₁ or does not move any closer to the vehicle 10, then the controller 22 will instruct the window system to return to the sleep mode after a predefined period of time has lapsed, such as 2 minutes. If, however, the recognized user follows path A and passes through a second threshold distance T₂ from the vehicle 10, which is represented by another dashed line spaced-apart from the vehicle 10 by the second threshold distance T₂, then the controller 22 will instruct the window 32 to move to the pre-drop position. The second threshold distance T₂ is about 3 meters in one example.

In a further aspect of this disclosure, when the recognized user enters within the second threshold distance T₂, the controller 22 is able to determine which of the doors 12, 14, 16, 18 the recognized user 68 is likely to attempt to open based on a proximity of the recognized user 68 to a particular one of the doors 12, 14, 16, 18 and/or based on the path of travel of the recognized user 68. In an example, the controller 22 will instruct only the window corresponding to the closest door 12, 14, 16, 18 to the recognized user 68 to move the pre-drop position. In FIG. 6, the recognized user 68 following path A walks directly to door 12, and thus the controller 22 only instructs the window 32 of door 12 to move to the pre-drop position. In another example, the controller 22 may command all doors on the same side as the recognized user 68 to move to the pre-drop position. In that example, the recognized user 68 following path A would result in the windows of doors 12, 14 being moved to the pre-drop position, while maintaining the windows of doors 16, 18 in the fully closed position.

In this example, the recognized user 68 activates the door release assembly 40 of door 12, at which point the controller 22 instructs the window 32 to move to the short drop position. When in the short drop position, the recognized user 68 can then move the door 12 from the fully closed position. If, in this example, the window of the door 14 was moved to the pre-drop position but the door release assembly associated with door 14 was not activated within a predefined period of time, such as 2 minutes, then the window of door 14 would move back to the fully closed position. Likewise, if the recognized user 68 did not activate the door release assembly 40 of door 12 within the predefined period of time, the window 32 would move back to the fully closed position.

In another aspect of this disclosure, the controller 22 instructs the window 32 to move to the pre-drop position when the transmission of the vehicle 10 shifts to park from a gear other than park, such as drive or reverse. In this way, the window 32 is in the pre-drop position following a driving operation, during which time it is anticipated that a user may soon be exiting the vehicle 10. If the user does not exit within a predefined period of time, such as 2 minutes, then the window 32 will return to the fully closed position. In a further aspect of this disclosure, each window that was opened before a driving operation was performed will be pre-dropped when shifting into park from a gear other than park. In a further aspect of this disclosure, the windows corresponding to each door 12, 14, 16, 18 will be pre-dropped when shifting into park from a gear other than park.

In another aspect of this disclosure, the controller 22 instructs the one or more of the windows of the doors 12, 14, 16, 18, such as window 32, to move to the pre-drop position when an ignition of the vehicle 10 is off, such as when a key is turned to the off position, or when a button, such as a start/stop button, is pressed to turn off the vehicle 10. In this aspect, the window 32 is in the pre-drop position during a time when it is anticipated that a user may be soon exiting the vehicle 10.

In another aspect of this disclosure, the controller 22 instructs one or more of the windows of the doors 12, 14, 16, 18, such as window 32, to move to the pre-drop position when an SOC of the battery pack 20 is less than a threshold SOC, such as 40% SOC. In this way, the window 32 will be in the pre-drop position, and will be able to be opened, even if the battery pack 20 were to reach a 0% SOC. In a related aspect of this disclosure, the controller 22 instructs the window 32 to move to the pre-drop position when the vehicle 10 is not functioning or performing according to normal operational conditions, to permit the window 32 to open in those conditions.

In another aspect of this disclosure, the controller 22 instructs one or more of the windows of the doors 12, 14, 16, 18, such as window 32, to move to the pre-drop position when an ambient temperature is below a threshold temperature, such as a temperature near freezing, such as 37° F. In this way, even if ice freezes to the window 32, the door 12 can be opened by overcoming the force of the seal 46.

Directional terms such as “vertical,” “upward,” “downward,” “forward,” “rearward,” etc., are used herein for purposes of explanation and with reference to the orientation of components illustrated in the drawings. Such directional terms should not be considered limiting. Further, it should be understood that terms such as “generally,” “substantially,” and “about” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A window system for a motor vehicle, comprising:
a window moveable between a fully closed position, a pre-drop position, and a short drop position;
a sensor system configured to generate signals indicative of a presence of a recognized user adjacent the motor vehicle, and indicative of a proximity of the recognized user to the motor vehicle; and
a controller configured to instruct the window to move from the fully closed position to the pre-drop position when a signal from the sensor system indicates the recognized user is adjacent the motor vehicle.

2. The window system as recited in claim 1, wherein the controller is configured to instruct the window to move from the fully closed position to the pre-drop position when the signal from the sensor system indicates the recognized user is within about 3 meters of the motor vehicle.

3. The window system as recited in claim 1, wherein:
the controller is configured to instruct the window system to wake up from a low power mode when a signal from the sensor system indicates a recognized user is within a first threshold distance of the motor vehicle,
the controller is configured to instruct the window to move from the fully closed position to the pre-drop position when a signal from the sensor system indicates the recognized user is within a second threshold distance of the motor vehicle, and
the second threshold distance is less than the first threshold distance.

4. The window system as recited in claim 3, wherein the first threshold distance is about 10 meters, and the second threshold distance is about 3 meters.

5. The window system as recited in claim 1, wherein:
the window is a first window,
the window system further comprises a second window moveable between a fully closed position, a pre-drop position, and a short drop position, and
when the signal from the sensor system indicates the recognized user is adjacent the motor vehicle, the controller is configured to instruct a closer one of the first window and the second window to the recognized user to move from the fully closed position to the pre-drop position.

6. The window system as recited in claim 1, further comprising:
a door, wherein the window is moveable such that a height of an upper edge of the window relative to an upper edge of the door is variable in response to instructions from the controller; and
a seal mounted to a body section of the motor vehicle, wherein the body section is adjacent an upper edge of a window opening selectively covered and uncovered by movement of the window,
wherein, when the window is in the fully closed position, an upper edge of the window is within the seal,
wherein, when the window is in the pre-drop position, the upper edge of the window is within the seal but the upper edge of the window is arranged at a lesser height than in the fully closed position, and
wherein, when the window is in the short drop position, the upper edge of the window is not within the seal.

7. The window system as recited in claim 6, wherein the upper edge of the window moves a lesser distance when moving between the pre-drop and the short drop positions than when moving between the fully closed and short drop positions.

8. The window system as recited in claim 7, wherein the upper edge of the window moves a distance within a range of about 10-18 mm when moving between the pre-drop and the short drop positions, and the upper edge of the window moves a distance of about 2 mm between the fully closed and pre-drop positions.

9. The window system as recited in claim 6, wherein, when the window is in the pre-drop and short drop positions, there is a vertical clearance between the upper edge of the window and the body section such that the door can be moved from the fully closed position without the upper edge of the window contacting the body section.

10. The window system as recited in claim 1, further comprising:
a door mounted relative to an opening in a body of the motor vehicle such that the door is moveable between a fully closed position and a fully open position;
a door release assembly configured to permit movement of the door from the fully closed position, and
wherein, when the door release assembly is activated, the controller is configured to instruct the window to move from the pre-drop position to the short drop position.

11. The window system as recited in claim 10, wherein the door release assembly includes one or both of a door handle and a door presenter.

12. The window system as recited in claim 10, wherein the controller is configured to instruct the window to move from the pre-drop position to the fully closed position if the door release assembly is not activated within a predefined time period.

13. The window system as recited in claim 1, wherein the controller is configured to instruct the window to move from the fully closed position to the pre-drop position when a transmission of the motor vehicle is shifted into park from a gear other than park.

14. The window system as recited in claim 1, wherein the controller is configured to instruct the window to move from the fully closed position to the pre-drop position when an ignition of the motor vehicle is in an off position.

15. The window system as recited in claim 1, wherein the controller is configured to instruct the window to move from the fully closed position to the pre-drop position when an ambient temperature is below a threshold temperature.

16. The window system as recited in claim 1, wherein the controller is configured to instruct the window to move from the fully closed position to the pre-drop position when the motor vehicle is not operating in a normal operating condition.

17. An electrified vehicle, comprising:
a battery pack configured to deliver power to propel the electrified vehicle;
a window moveable between a fully closed position, a pre-drop position, and a short drop position; and
a controller configured to instruct the window to move from the fully closed position to the pre-drop position when a state of charge of the battery pack is less than a threshold.

18. The electrified vehicle as recited in claim 17, wherein the threshold is a 40% state of charge.

19. A method, comprising:
moving a window of a motor vehicle from a fully closed position to a pre-drop position when a recognized user is adjacent the motor vehicle.

20. The method as recited in claim 19, further comprising:
waking up a window system of the motor vehicle when the recognized user is within a first threshold distance of the motor vehicle; and
moving the window from the fully closed position to the pre-drop position when the recognized user is within a second threshold distance of the motor vehicle, wherein the second threshold distance is less than the first threshold distance.
